(19) United States
(12) Patent Application Publication
(10) Pub. No.: US 2002/0121970 A1
(43) Pub. Date: Sep. 5, 2002

(54) Electronic vanity display device

(76) Inventor: Jacob Alfred Brewer, Knoxville, TN (US)

Correspondence Address: JACOB ALFRED BREWER, 10042 DOUBLE TREE RD, KNOXVILLE, TN, 37932, US

(21) Appl. No.: 10/039,421

(22) Filed: Jan. 2, 2002

Related U.S. Application Data
(60) Provisional application No. 60/259,580, filed on Jan. 2, 2001.

(51) Int. Cl. B60Q 1/00

(52) U.S. Cl. 340/425.5; 340/815.4

(57) ABSTRACT

A method and apparatus for an electronic vanity display device (10) comprising a vanity display screen (30) that is affixed to the exterior of a commercially or privately owned method of ground transportation (50) for viewing text, graphics, and digital photographs. The electronic vanity display device (10) further comprises a display composition computer (20) used to create a composition of text, graphics, and digital photographs that is displayed using the exterior vanity display screen (30). The composed text and graphics can be edited and displayed at any time by the operator of the display composition computer (20). The vanity display device may display previously constructed compositions that are input from various electronic or optical storage media via the display composition computer (20). The vanity display device (10) may be connected to the Internet through the use of a wireless communications device (such as a cell phone) to download text, graphics, photographs, or previously constructed compositions.

### FIELD OF INVENTION

The present invention relates generally to vehicular display devices. In particularly, the present invention relates to an electronic vanity display device for mounting on a method of ground transportation. In particular, the present invention relates to electronic, interactive, bumper stickers.

### BACKGROUND OF THE INVENTION

There are many ways that private citizens express their thoughts and feelings by placing printed material onto methods of ground transportation. The expression of these thoughts and feelings have taken physical, three dimensional form as well, comprised of a composition of wood, metal, plastics, and other common construction materials in the shape of various objects that are displayed in or on a method of ground transportation. A standard method for private citizens to express their thoughts and feelings is to construct or purchase a bumper sticker and place the bumper sticker onto the outside of a method of ground transportation, preferably towards the rear of the method of ground transportation and on the rear bumper or aperture of a method of ground transportation. Unfortunately, once the bumper sticker is placed onto the automobile, it may soon become outdated with respect to the ground transportation owneris present thoughts or feelings. The common ground transportation bumper sticker is constructed to remain on the bumper regardless of the types of weather that it experiences and is therefore not easily removed if so desired. Hence, this particular set of prior art methods and devices has been unable to adequately address the ability of a ground transportation owner to express different thoughts or feelings easily and in a timely manner. Attempts to use bumper stickers to reflect the present thoughts or feelings of any ground transportation owner have therefore met with limited success.

As further example, to address the bumper sticker problem, Courtney, U.S. Pat. No.5,622,389, describes a bumper device and method to provide a hassle-free system for mounting and replacing bumper stickers. The bumper sticker device is attached to the bumper using Velcro strips to permit easily removal. However, the method and apparatus requires the reconstruction or repurchase of a second bumper sticker, with the additional step of preparing it with Velcro strips for use with the apparatus, to change the first bumper sticker to a second one. Therefore, the attempt to employ the Courtney bumper sticker apparatus to reflect the present, changing thoughts or feelings of a ground transportation owner meets with limited success.

Reas, U.S. Pat. No. 5,099,594, describes a ground transportation-mounted message display with suction cups and interposed hook and loop fasteners. The message display comprises a dry-erase message board that can be displayed on the interior surface of the ground transportation window. The message board can be temporarily detached from the affixing mechanism so that any desired message can be written, displayed, erased, or changed on the board. Once the desired changes are completed, it is reattached. The method and apparatus does not provide for the messaging and imaging possibilities that are presently available through the use of graphics software on standard laptop computers. The messaging process is slow and cumbersome. A further example of a limited display composition ability is illustrated by Kinloch, U.S. Pat. No. 4,470,214. Kinloch describes a display sign for the rear window area of a method of ground transportation, in which different posters are displayed. A poster placed in the display sign may be removed so as to place a second different poster. Again, the messaging process is slow and cumbersome. Therefore, attempts to employ the Reas message display apparatus or the Kinloch display sign apparatus to reflect the present, changing thoughts or feelings of a ground transportation owner meets with limited success.

The present invention represents vanity display device comprising a display screen that is affixed to the exterior of a commercially or privately owned method of ground transportation for viewing text, graphics, and digital photographs. The vanity display device further comprises a display composition computer used to create a composition of text, graphics, and digital photographs that is displayed using the exterior display screen. The display composition computer is mounted or placed inside the method of ground transportation to provide quick and easy access to the composition software operating on the display composition computer. The composed text and graphics can be edited and displayed at any time by the operator of the display composition computer. We have applied the vanity display device to overcome these limitations. There are no such teachings in the prior art.

Smith, U.S. Pat. No. 5,105,179, describes a method and apparatus for an electronic display license plate and message center for use on any method of ground transportation. The electronic display license plate is a replacement for the standard metal license plate. Further, the configuration cartridge, such as a read only memory, contains such information as license plate data. However, this invention does not permit any ability to use this information, or any other electronically stored information, to express a ground transportation owneris present thoughts or feelings. Further, in the background for Smith, a good review of the existing prior art regarding a license plate and message center apparatus clearly demonstrates that no prior art apparatus provides an electronic bumper sticker that may be reconfigured with general, electronically stored data that may be composed to express a ground transportation owneris present thoughts or feelings. The U.S. Pat. No. 5,105,179 is thereby incorporated herein by reference in its entirety.

### SUMMARY OF THE INVENTION

The present invention is an apparatus to provide interactive, electronic, real-time adaptable, vanity displays to a display screen that is attached to a method of ground transportation. An operator or passenger of a method of ground transportation uses the vanity display device to construct, compose, or combine vanity displays that are electronically posted real-time to the vanity display screen. The vanity display device comprises a display composition computer located within an operator or passenger seating area of said method of transportation, a vanity display screen attached to an exterior section of said method of transportation, and a wiring harness connected to said display composition computer and connected to said vanity display screen. The display composition computer is used by the ground transportation operator or passenger to interactively communicate one or more electronic displays to the display screen.

The benefits of this invention will become clear and will be best appreciated with reference to the detailed description of the preferred embodiments. Other objects, advantages and novel features will be apparent from the description when read in conjunction with the appended claims and attached drawings.

### Objects and Advantages

Furthermore, the Electronic Vanity Display Device has the additional advantages in that it permits the user to change the displayed composition at anytime they feel that theyive grown out of the old one without the reapplication of physical material displays; it permits the user to create new display compositions without further cost of physical material; it allows the user to create display compositions in conjuncture with new technology and application methods such as electronically stored media and electronically updated media via the Internet; and it provides a way a person can actively exhibit there current changing thoughts and feelings via real-time adaptability.

### DRAWING FIGURES

FIG. 1 illustrates the electronic vanity display device attached to a method of ground transportation, comprising the display composition computer, the vanity display screen, and the connecting power and communication harness.

FIG. 2 illustrates a frontal view of the display composition computer with buttons for operation and interaction.

FIG. 3 illustrates a frontal view of the electronic vanity display screen.

### Reference Numerals in Drawings

| | | | |
|---|---|---|---|
| 10 | electronic vanity display | 20 | display composition computer |
| | device | | |
| 30 | vanity display screen | 40 | wiring harness |
| 50 | ground transportation | 60 | display composition computer |
| | | | screen |
| 70 | digital pen | 80 | memory card drive |
| 90 | compact disk drive | 100 | cell phone data transfer port |
| 110 | battery recharging port | 120 | microphone |
| 130 | on and off switch | 140 | clip art graphics |
| 150 | foreground | 160 | background |
| 170 | folder | 180 | Internet connection |
| 190 | voice operation | 200 | affixing mechanism |
| 210 | background display lighting | 220 | foreground display |
| 230 | displayed foreground | | |
| | composition | | |

### DESCRIPTION-PREFERED EMBODIMENT

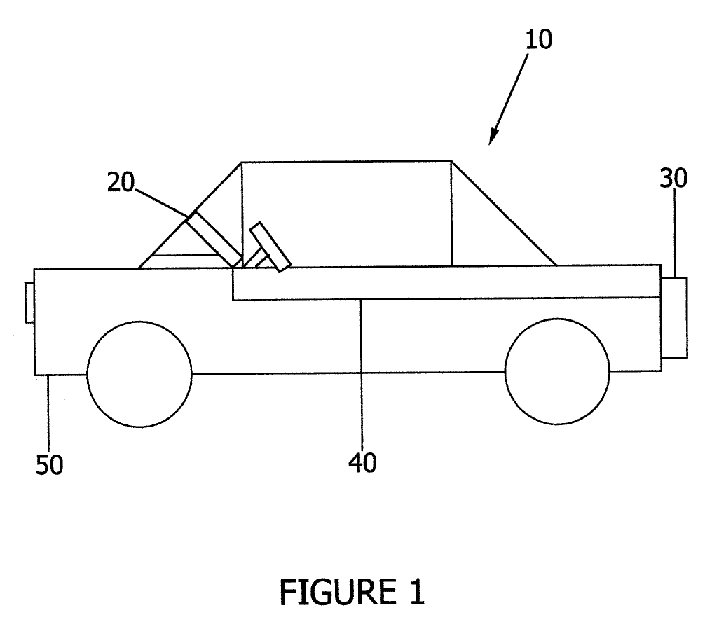

FIG. 1 illustrates the present invention in its preferred embodiment. The electronic vanity display device 10 comprises a vanity display screen 30 that is affixed to the exterior of commercially or privately owned ground, water, or air transportation 50 for viewing text, graphics, and digital photographs. The present invention is attached to an exterior part of any method of ground transportation 50, such as commercial or privately owned motor vehicles, automobiles, buses, trains, and subways and boats and ships and airplanes.

The vanity display device 10 further comprises a display composition computer 20 used to create a composition of text, graphics, and digital photographs that is displayed using the exterior vanity display screen 30. The display composition computer 20 is connected to the vanity display screen 30 by a wiring harness 40. The wiring harness 40 comprises at least one power wire and at least one communication wire from the display composition computer 20 to the vanity display screen 30.

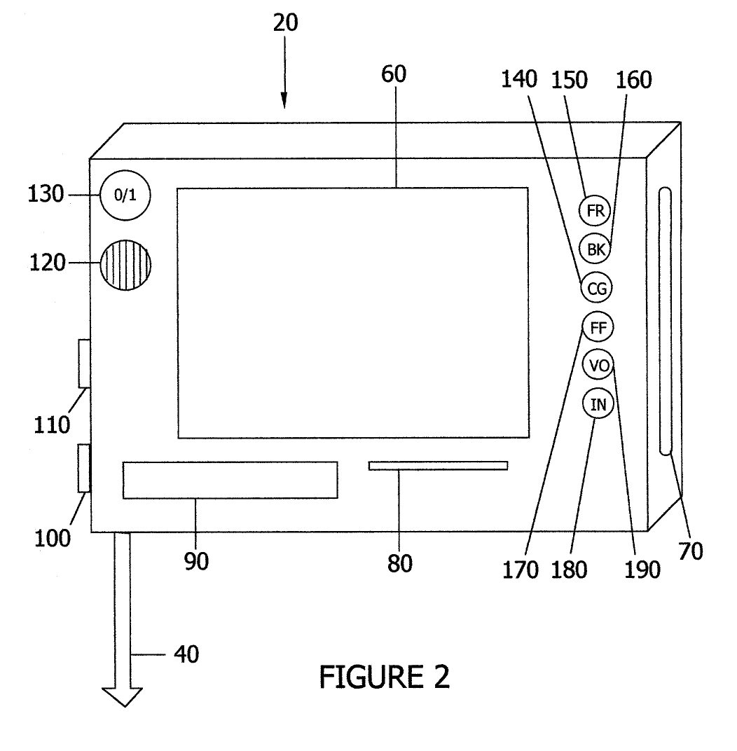

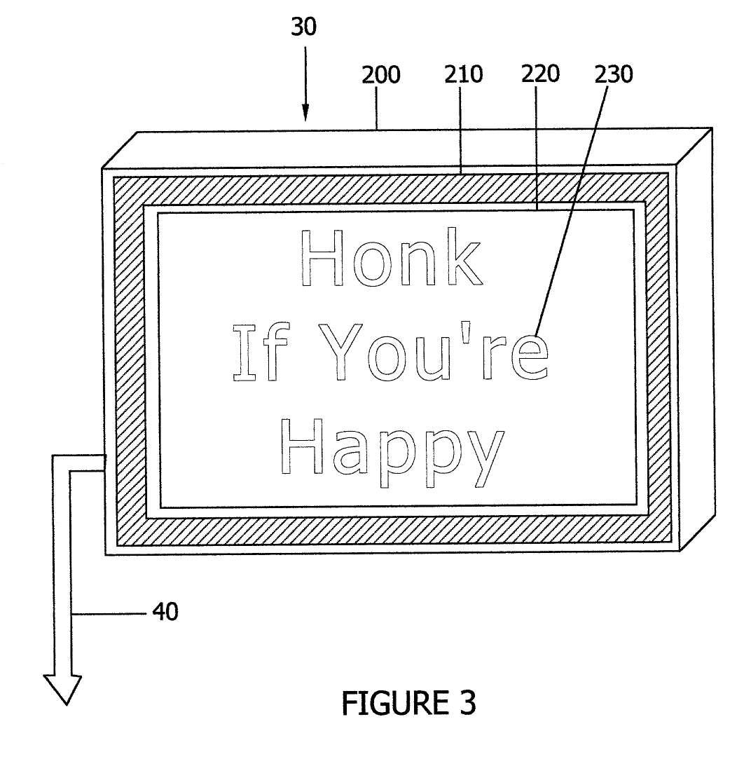

FIGS. 2 and 3 illustrate the display composition computer 20 of the present invention. The display composition computer 20 may take the form of a standard computer, such as a Macintosh or PC laptop. The display composition computer 20 may also be a portable workstation laptop. The display composition computer 20 may also take the form of a personal digital assistant device, such as a commercially available Palm Pilot or Handspring digital data display device.

The display composition computer 20 is turned on or turned off by using an on/off button 130. The display composition computer 20 is operated by pressing appropriate buttons 140, 150, 160, 170, 180, or 190 by touching the display composition computer screen 60 with a finger or a digital pen 70. A digital pen 70 and its holder slot 70 is located on a side of the display composition computer 20.

The display composition computer 20 has buttons to operate digital data to construct or compose vanity displays. The display composition computer buttons may be physically located on the display composition computer or may be virtually implemented as software buttons in the form of a touch screen and soft keys.

The foreground button 150 permits the user to compose the foreground of the vanity display. The vanity display foreground 230 comprises a combination of text, graphics, or photographs. The background button 160 permits the user to compose the background 210 of the vanity display.

The clip art graphics button 140 permits the user to draw from a large library or database of clip art graphics and photographs to be placed into the foreground 230 of the vanity display 220. The library or database of clip art graphics and photographs are stored on a hard disk drive within the display composition computer 20. The file and folder button 170 permits the user to save, delete, open, or close composed vanity displays as files within folders in a like manner as methods available through a Macintosh or PC operating system. The owner or user of the vanity display device places a selected vanity display onto the vanity display screen using the files and folder menu options.

The voice operation button 190 permits the user to operate the vanity display device by voice actuation. By pressing the voice operation button and by verbally stating simple commands, the display composition computer 20 uses a microphone 120 to intercept, interpret, and perform simple functions related to the commands. As an illustration, a first simple set of verbal commands opens a preexisting, predetermined vanity display and places the display onto the vanity display screen 30. As a further illustration, a second simple set of verbal commands opens a second, preexisting, predetermined vanity display and replaces the first display with the second display onto the vanity display screen 30.

The vanity display device 10 may be connected to the Internet through the use of a wireless communications device, such as a cell phone, to download text, graphics, and photographs. The vanity display device 10 may also download or upload fully constructed vanity display compositions. The Internet connection button 180 permits the user to connect to the Internet via the display composition computer 20 and a cell phone attached to a cell phone data transfer port 100. The display composition computer 20 uses the cell phone and cell phone data transfer port 100 to interactively communicate to the Internet.

The display composition computer 20 has several standard, commercially available subsystems that permit the transfer of data in the form of text, graphics, photographs, or composed vanity displays. The display composition computer 20 uses its memory card drive 80, compact disk (CD) drive 90, or cell phone data transfer port 100 to download or upload digital data and composed vanity displays to construct vanity displays interactively and in real-time.

The display composition computer 20 is powered by rechargeable batteries in a manner similar to present day cell phones. The display composition computer 20 supplies power to the vanity display screen 30 via the wiring harness 40. The owner of the vanity display device 10 and its display composition computer 20 may recharge the batteries using an adapter to access a homeis or businessi electricity supply to recharge the batteries. The owner may also recharge the batteries using an adapter to access a ground transportation apparatusi 50 electricity supply through its cigarette lighter or power outlet.

The display composition computer 20 is preferably mounted on the dashboard of the method of ground transportation 50. The mounting is a clip-on, such as is presently used for clipping cell phones to the dashboard of ground transportation 50. The display composition computer 20 may be lifted from the mounting and held by hand for operation. The text, graphics, and photograph pieces that comprise a vanity display composition can be edited and displayed at any time during the operation of the display composition computer 20. The vanity display screen 30 may display previously constructed compositions that are input from various electronic or optical storage media via the display composition computer 20.

The vanity display screen 30 is preferably attached to the exterior and rear of a method of ground transportation 50. The vanity display screen 30 allows a vanity display to be readily broadcast. The electronic vanity display screen 30 ranges from the size of an ordinary bumper sticker (approximately 12 inches long and 4 inches wide) to the size of a large television flat screen (approximately 48 inches long and 24 inches wide). Using a larger electronic vanity display screen 30 is beneficial for commercial transportation such as taxi cabs and buses and subways.

The vanity display screen 30 comprises an active liquid crystal display 220 such as a screen used for standard computer laptops. The vanity display screen 30 displays a vanity display communicated by the display composition computer 20, serving a display function comparable to a laptop computer screen. The vanity display device 10 is therefore able to create and display any display composition that is possible using standard computer software developed to combine text, graphics, or photographs. Examples of such computer software are Corel Draw and Adobe Illustrator. Also, the display composition computer 20 employs HTML and dynamic HTML capabilities to construct web page like displays to emulate Internet web page constructions. The web page constructions are an example of the vanity displays that can be composed. The web page constructions, as display compositions, are communicated to the vanity display screen 30 for display.

The vanity display screen 30 further comprises a background 210. The background 210 comprises a border surrounds the vanity display screen foreground 220 and that incorporates lights that are programmable via the background button 160 on the display composition computer 20. The background lighting 210 is programmable to operate display lights that illuminate the foreground 220 of the vanity display screen 30 for better viewing. The background lighting 210 is also programmable to activate its lights in a flashing manner and with an active and changing lighting pattern. The outer cover for the background lighting 210 is a plastic cover that is interchangeable. The plastic cover is colored clear or with colors that enhance the lighting of the foreground 220 or the lighting pattern displays.

The vanity display screen 30 may be attached in many different manners to the method of ground transportation 50 with an affixing mechanism 200. The vanity display screen 30 may be attached using bumper sticker glue, Velcro, or a metal back plate. The vanity display screen 30 is covered with a clear plastic material to protect the electronics from the weather and outside environment. Further, the plastic material further enhances the viewing of the vanity display screen 30. For example, the vanity display screen 30 may be mounted using the bumper device and method described in U.S. Pat. No. 5,622,389, incorporated herein by reference in its entirety. As a second example, the vanity display screen 30 may be mounted using the interchangeable display system for indicia described in U.S. Pat. No. 5,266,144, incorporated herein by reference in its entirety.

### Alternative Embodiments

There are various possibilities with regard to the relative disposition of the construction of the Vanity Display Device. As an alternative embodiment, it is constructed to allow the display composition computer and the vanity display screen to communicate without the use of a wiring harness. There are numerous wireless communication methods and apparatus that permit the display composition computer to communicate to the vanity display screen. As an example, a simple radiofrequency transceiver technology can be employed as a wireless communication capability. As another example, the display composition computer and the vanity display screen can have built-in cell phone technology to communicate between the two devices. As another example, the display composition computer links to the Internet to upload a composed display into a shared data access location and the vanity display screen wirelessly links to the Internet to download a composed display from the shared data access location.

As an alternative embodiment, the vanity display screen is constructed to use portable power supply, such as at least one battery. The battery can be a disposable type, such as an alkaline battery, or the battery can be a rechargeable type, and a rechargeable battery may comprise one of the several rechargeable technologies, such as the nickel-cadmium or the lithium rechargeable chemical technologies. The battery recharging port 110 provides access to the batteries for the vanity display device 10. As an alternative embodiment, the vanity display screen is constructed to use solar energy via a solar cell collector technology for power. The vanity display screen has a simple solar energy collector system similar to those systems built into calculators, such that the energy is collected and stored for use at a later time, or is collected and used during the time of operation.

### Conclusion

The Electronic Vanity Display Device is a method and apparatus to permit a person to express their present thoughts and feelings in real-time to be displayed on the exterior of an object to which the vanity display screen can be attached. Furthermore, the Electronic Vanity Display Device has the additional advantages in that it permits the user to change the displayed composition at anytime they feel that the previous displayed composition without the reapplication of physically material displays; it permits the user to create new display compositions without further cost of physical material; it allows the user to create display compositions in conjuncture with new technology and application methods such as electronically stored media and electronically updated media via the Internet; and it provides a way a person can actively exhibit there current changing thoughts and feelings via real-time adaptability.

Those skilled in the art will recognize that the embodiments disclosed herein are exemplary in nature and that various changes can be made therein without departing from the scope and the spirit of this invention. The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

I claim:

1. An electronic vanity display device comprising:
(a) a display composition computer located within an operator or passenger area of an apparatus for transportation;
(b) a vanity display screen attached to an exterior section of said apparatus for transportation; and
(c) a communications link connected to said display composition computer and connected to said vanity display screen,
whereby said display composition computer communicates at least one display to said vanity display screen.

2. The apparatus of claim 1, wherein said display composition computer is selected from the group consisting of personal computers and portable computer workstations and personal digital assistant devices.

3. The apparatus of claim 1, wherein said vanity display screen is selected from the group consisting of personal computers and portable computer workstations and personal digital assistant devices.

4. The apparatus of claim 1, wherein said apparatus of transportation is selected from the group consisting of commercially and privately owned motor vehicles and automobiles and buses and trains and subways and boats and ships and airplanes.

5. The apparatus of claim 1, wherein said electronic communications link comprises a wiring harness with at least one power wire and with at least one communication wire from said display composition computer to said vanity display screen.

6. The apparatus of claim 1, wherein said electronic communications link comprises a wireless communications technology.

7. The apparatus of claim 6, wherein said wireless communications technology is a radiofrequency transceiver technology.

8. The apparatus of claim 1, wherein said vanity display screen is powered separately from said display composition computer using a portable power supply such as a battery.

9. The apparatus of claim 8, wherein said vanity display screen is powered using a portable power supply such as a battery.

10. The apparatus of claim 1, wherein said display composition computer is operated using a touch screen and soft keys to implement a set of operational functions.

11. The apparatus of claim 1, wherein said display composition computer is operated using a voice actuator and automatic interpretation software to implement a set of operational functions.

12. The apparatus of claim 1, wherein said display composition computer further comprises an interactive communications link to the Internet to perform at least one operational function using available functions and data on the Internet.

13. The apparatus of claim 1, wherein said display composition computer further comprises a large library or database of clip art graphics and photographs.

14. The apparatus of claim 13, wherein said database of graphics and photographs is stored and is accessible on the Internet via an interactive communications link.

15. The apparatus of claim 1, wherein said vanity display screen further comprises an active liquid crystal display.

16. The apparatus of claim 1, wherein said display composition computer further comprises static and dynamic Internet web page construction and display capabilities.

17. The apparatus of claim 1, wherein said vanity display screen further comprises static and dynamic Internet web page construction and display capabilities.

18. The apparatus of claim 1, wherein said vanity display screen further comprises a solar cell collector technology for power.

19. An electronic vanity display device comprising:
(a) a display composition computer located within an operator or passenger area of a privately owned motor vehicle;
(b) a database of graphics and photograhs connected to said display composition computer;
(c) a vanity display screen attached to an exterior section of said privately owned motor vehicle; and
(d) a power and communication wiring harness connected to said display composition computer and connected to said vanity display screen,
whereby said display composition computer communicates at least one electronic display to said vanity display screen.

20. An electronic vanity display device comprising:
(a) a display composition computer located within an operator or passenger area of an automobile;
(b) a database of graphics and photograhs accessible through the Internet;
(c) a cell-phone communications link connected to said display composition computer and connected to the Internet to store, retrieve, and construct displays using said graphics and photographs in said database;
(d) a self-powered vanity display screen attached to an exterior section of said automobile;
(e) a cell-phone communications link connected to said vanity display screen and connected to the Internet to retrieve at least one display in said database; and
(f) a radiofrequency communications link connected to said display composition computer and connected to said vanity display screen,
whereby said display composition computer communicates at least one electronic display to said vanity display screen.
